(19) United States
(12) Patent Application Publication
(10) Pub. No.: US 2007/0039630 A1
(43) Pub. Date: Feb. 22, 2007

(54) Wet clean and drying method and apparatus

(76) Inventor: Woo Sik Yoo, Palo Alto, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/208,806

(22) Filed: Aug. 22, 2005

(51) Int. Cl. B08B 3/12

(52) U.S. Cl. 134/1.3; 134/18; 134/30; 134/61; 134/105; 134/186

(57) ABSTRACT

Systems and techniques for cleaning, including a reservoir with a first portion and a second portion. The first portion is configured to contain fluid under a receiving surface of the fluid. The second portion is configured to contain fluid under a transmitting surface of the fluid separate from the receiving surface of the fluid.

### BACKGROUND

1. Field of Invention

This invention generally relates to cleaning and, more particularly, to systems and techniques for wet cleaning and drying.

2. Related Art

In the manufacture of electronic and micromechanical devices, one or more cleaning steps may be performed to remove contaminants. For example, in the manufacture of semiconductor devices, substrates may be cleaned prior to and/or after processing steps (e.g., after a chemical mechanical polishing process).

As device dimensions decrease, manufacturing techniques and processes may need to be improved, and new processes developed to satisfy increasingly stringent design specifications. Existing cleaning systems and techniques may not efficiently achieve minimum acceptable contamination limits for small device feature sizes.

FIG. 1A shows an example of a cleaning system 100 that may be used in a device production process. System 100 includes a reservoir 110 for an aqueous solution 120 (such as deionized water). A substrate 130 is introduced into solution 120 using a robot 140. Substrate 130 is cleaned in solution 120; that is, contaminants from the substrate surface move into solution 120 due to interaction with solution 120. Some contaminants may remain in solution 120, while others may move to surface 122 of solution 120, or may adhere to an inner surface of reservoir 110. System 100 may implement additional cleaning techniques, such as ultra- or mega-sonic cleaning, cleaning at elevated temperatures, and other techniques.

Substrate 130 is then removed from solution 120 and dried. In some systems, a region 125 including solvent fluid (e.g., isopropyl alcohol vapor in nitrogen gas) adjacent the surface of solution 120 may be used to dry substrate 130.

Although system 100 may be sufficient for some applications, it may not be optimal for others, due to recontamination. FIG. 1B shows an exemplary side view of system 100, illustrating recontamination of substrate 130 upon its removal from solution 120. Contaminants on surface 122 of solution 120 (such as oil particles that have been removed from substrate 130 during the cleaning process) may re-coat the substrate surface as substrate 130 is removed from solution 120. This recontamination may be unacceptable for some cleaning processes.

### SUMMARY

Systems and techniques herein may provide for efficient cleaning; for example, for cleaning one or more substrates.

In general, in one aspect, a cleaning system comprises a reservoir including a first portion and a second portion. The first portion may be configured to contain fluid under a receiving surface of the fluid. The second portion may be configured to contain fluid under a transmitting surface of the fluid separate from the receiving surface of the fluid. The reservoir may include an input configured to receive fluid and an output configured to transmit fluid. The reservoir may include a third portion positioned between the first portion and the second portion.

In general, in another aspect, a cleaning method may comprise providing a reservoir including a cleaning solution. The method may further comprise introducing a part into the cleaning solution via a receiving surface of the cleaning solution. The part may be substantially cleaned in a first region of the cleaning solution positioned at least partially under the receiving surface. The part may be transmitted to a second region of the cleaning solution at least partially under a transmitting surface of the cleaning solution. The part may be removed from the cleaning solution via a transmitting surface of the cleaning solution separate from the receiving surface. The method may further comprise transmitting the part through vapor including one or more drying agents upon removing the part from the cleaning solution.

In general, in another aspect, a device manufacturing system may comprise a cleaning module comprising a reservoir having a first portion and a second portion. The second portion may be configured to contain fluid under a transmitting surface of the fluid separate from the receiving surface of the fluid. The system may further comprise a process module, the process module configured to receive one or more substrates from the cleaning module, to transmit one or more substrates to the cleaning module, or both. The process module may be a semiconductor process module. The cleaning module may be integrated with the process module, or may be separate. The system may further include a controller configured to receive information indicative of one or more cleaning process parameters from at least one of the cleaning module and the process module. The controller may be further configured to provide information indicative of one or more control parameters to at least one of the cleaning module and the process module.

These and other features and advantages of the present invention will be more readily apparent from the detailed description of the exemplary implementations set forth below taken in conjunction with the accompanying drawings.

### BRIEF DESCRIPTION OF THE DRAWINGS

FIG. 1A is a cross-sectional front view of a cleaning system according to the prior art;

FIG. 1B is a cross-sectional side view of the system of FIG. 1A;

FIG. 2 is a cross-sectional front view of a cleaning system, according to some implementations;

FIG. 3 is a schematic illustration of a processing system, according to some implementations.

FIG. 4 shows a flow chart of a cleaning process, according to some implementations.

Like reference symbols in the various drawings indicate like elements.

### DETAILED DESCRIPTION

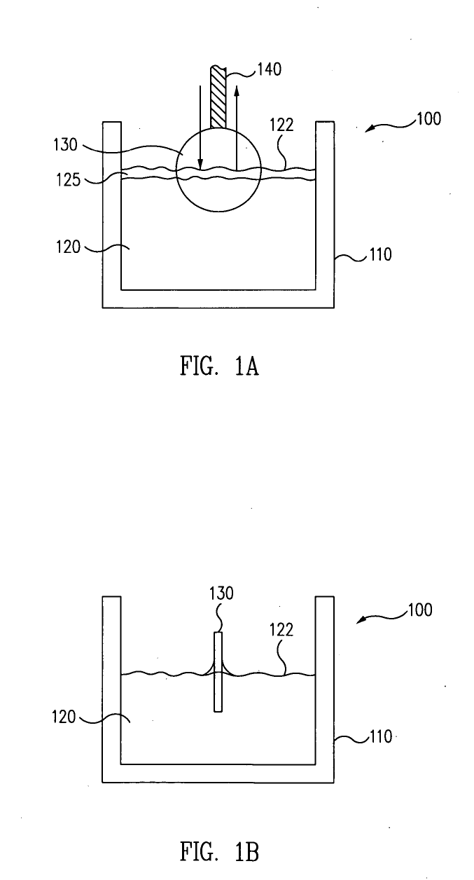

As noted above, a system such as system 100 of FIGS. 1A and 1B may not be optimal for some cleaning applications. For example, recontamination of the wafer upon removal from the cleaning solution may exceed contamination limits. Multiple cleaning cycles (and/or additional cleaning techniques) may be needed to ensure that the wafer is sufficiently clean of contaminants, which adds to the cost and complexity of the cleaning process.

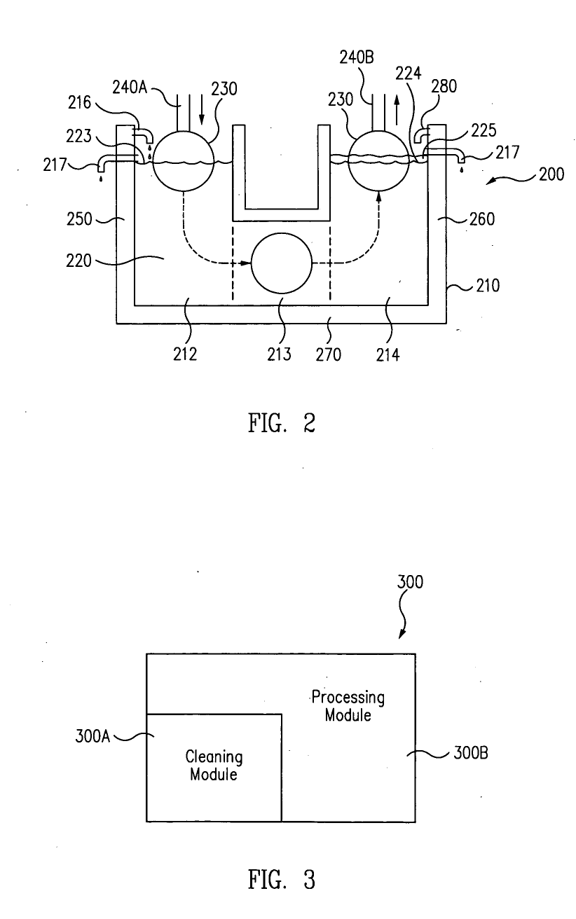

Systems and techniques provided herein may provide a more efficient cleaning process. FIG. 2 shows a system 200, according to some implementations. A cleaning reservoir 210 includes a first portion 250 to contain fluid (e.g., solution 220) in a region 212 positioned under a receiving surface 223 of solution 220. Reservoir 210 further includes a second portion 260 to contain fluid in a region 214 under a transmitting surface 224 separate from the receiving surface 223. Reservoir 210 may include one or more inlets 216 and one or more outlets 217 for introducing and/or removing fluid from reservoir 210.

In operation, cleaning solution 220 may be introduced into cleaning reservoir 210 using inlet 216 of solution 220. A substrate 230 to be cleaned is introduced into solution 220 via receiving surface 223. Substrate 230 may be substantially cleaned in a first region 212 positioned below receiving surface 223, so that contaminants travel to receiving surface 223 rather than transmitting surface 224.

Substrate 230 may be transported to second region 214. In some implementations, first region 212 and second region 214 may be separated by an intermediate fluid region 213 contained by a third portion 270 of reservoir 210, as shown in FIG. 2. In other implementations, receiving surface 223 and transmitting surface 224 may be separated by a thin partition, so that first region 212 and second region 214 are substantially adjacent each other. Substrate 230 may be removed from solution 220 via transmitting surface 224. Because substrate 230 was substantially cleaned in region 212 of solution 220, the number of contaminants removed in region 214 is reduced (or eliminated), and thus transmitting surface 224 is relatively free of contaminants. Thus, recontamination is substantially reduced or eliminated in system 200.

System 200 may include one or more features to enhance drying substrates as they are removed from solution 220. For example, system 200 may include an inlet 280 for providing drying fluid including one or more drying materials, such as isopropyl alcohol vapor in nitrogen gas. As substrate 230 is removed from solution 220, drying material may interact with solution 220 on the surface of substrate 230 and carry solution 220 from substrate 230.

Substrate 230 may be transported using one or more robots such as robot 240A and robot 240B of FIG. 2. In some implementations, a separate transport mechanism may be used to move substrate 230 through at least part of intermediate region 213. Other transport systems and techniques may be used.

System 200 may include one or more outlets such as outlets 217 and 217′ to allow excess solution (overflow) to drain from reservoir 210, and/or to be used during a fluid regeneration process. Fluid may be drained from reservoir 210 and replaced (regenerated) after every cleaning cycle, or multiple cycles may be performed prior to draining fluid from reservoir 210 and replacing it with clean fluid. In some implementations, fluid may be continuously or intermittently regenerated by providing clean fluid using inlet 216 and removing excess fluid using outlet 217 (i.e., rather than fully draining reservoir 210 through outlet 217′ and replacing the fluid).

System 200 may also include features to implement additional cleaning methods. For example, the first region of reservoir 210 may include features for ultra- and/or mega-sonic cleaning, such as one or more transducers. In another example, the first region of reservoir 210 may include features for cleaning at elevated temperatures, such as one or more heaters, and one or more temperature detectors.

System 200 may include one or more features to control cleaning techniques. For example, system 200 may include one or more data processing systems (not shown) to receive information indicative of one or more process parameters, and to provide information indicative of one or more control parameters. For example, information indicative of a temperature of solution 220 may be received by a controller, processed, and information indicative of one or more control parameters for heating solution 220 may be provided.

In another example, information indicative of a measured contamination level of at least one cleaned substrate may be received, and information indicative of one or more control parameters may be provided based on the received information. For example, a time in which a substrate remains in region 212 of solution 220 may be increased or decreased based on the received information, and control parameters may be provided to system 200 based on the updated time. Many other implementations are possible.

A cleaning system such as system 200 of FIG. 2 may be provided with one or more processing modules, as an integrated or separate part of a processing system for production of electronic and/or mechanical devices. FIG. 3 shows an implementation of a system 300 in which a cleaning system 300A is integrated with a processing module 300B. However, cleaning system 300A may be fully or partially separate from processing module 300B.

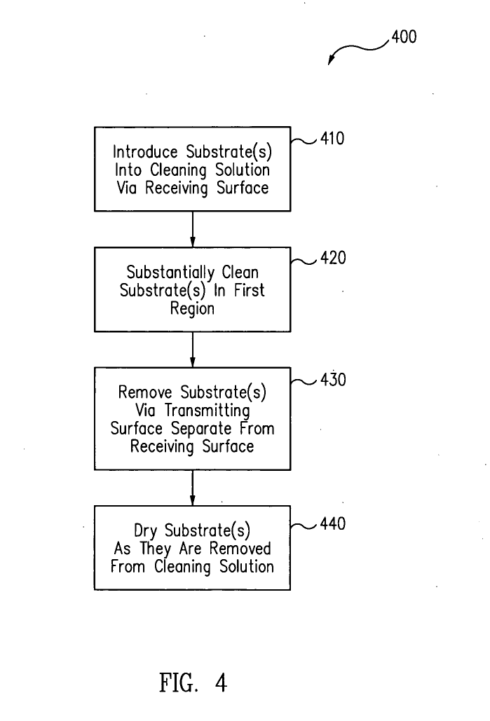

FIG. 4 shows a process 400 that may be used to clean one or more substrates. At 410, one or more substrates may be introduced into a cleaning solution via a receiving surface of the cleaning solution. At 420, the one or more substrates may be substantially cleaned in a first region of the cleaning solution under the receiving surface. At 430, the one or more substrates may be removed from the cleaning solution via a transmitting surface of the cleaning solution separate from the receiving surface. At 440, fluid including one or more drying materials may be used to dry the one or more substrates as they are removed from the cleaning solution.

A number of implementations have been described. Nevertheless, it will be understood that various modifications may be made without departing from the spirit and scope of the invention. For example, multiple cleaning systems may be used with a single processing module, or vice versa. The geometry of FIG. 2 is illustrative only; other configurations may be used. Additionally, different or additional fluids than those discussed above may be used in the first portion and/or the second portion of the reservoir. Although a single substrate has been shown, multiple substrates may be cleaned. For example, a cassette of substrates may be cleaned at the same time. Further, although a single cleaning cycle has been described, multiple cycles may be performed if desired. Accordingly, other implementations are within the scope of the following claims.

Also, only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A substrate cleaning system comprising:
an input configured to receive fluid;
a reservoir configured to receive fluid from the input, the reservoir including a first portion and a second portion, wherein the first portion of the reservoir configured to contain fluid under a receiving surface of the fluid, and wherein the second portion of the reservoir is configured to contain fluid under a transmitting surface of the fluid separate from the receiving surface of the fluid; and
an output configured to receive fluid from the reservoir and to transmit fluid.

2. The cleaning system of claim 1, wherein the reservoir further includes a third portion positioned between the first portion and the second portion.

3. The cleaning system of claim 1, further comprising one or more heaters positioned to heat fluid in the reservoir.

4. The cleaning system of claim 1, further comprising one or more transducers positioned to generate at least one of ultra-sonic and mega-sonic waves in the fluid.

5. The cleaning system of claim 1, further comprising the fluid included in the first region and the second region.

6. The cleaning system of claim 1, wherein the fluid comprises an aqueous solution.

7. The cleaning system of claim 1, further comprising another inlet, the another inlet configured to provide one or more drying materials to the reservoir adjacent the transmitting surface.

8. The cleaning system of claim 1, wherein the one or more drying materials comprises a solvent.

9. A cleaning method comprising:
providing a reservoir including a cleaning solution;
introducing a part into the cleaning solution via a receiving surface of the cleaning solution;
substantially cleaning the part in a first region of the cleaning solution positioned at least partially under the receiving surface;
transmitting the part to a second region of the cleaning solution, the second region positioned at least partially under a transmitting surface of the cleaning solution; and
removing the part from the cleaning solution via a transmitting surface of the cleaning solution separate from the receiving surface.

10. The method of claim 9, further comprising:
transmitting the part through vapor including one or more drying agents upon removing the part from the cleaning solution.

11. The method of claim 9, wherein substantially cleaning the part in the first region comprises cleaning the part using at least one of ultra- and mega-sonic cleaning techniques.

12. The method of claim 9, wherein substantially cleaning the part in the first region comprises heating at least a portion of the solution in the first region.

13. The method of claim 9, wherein substantially cleaning the part in the first region comprises controlling one or more cleaning techniques based on received information indicative of one or more cleaning parameters.

14. The method of claim 13, wherein the one or more cleaning parameters comprises at least one of a measured contamination amount, and a measured temperature.

15. A device manufacturing system comprising:
a cleaning module, the cleaning module comprising:
a reservoir configured to receive fluid from an input, the reservoir including a first portion and a second portion, wherein the first portion of the reservoir configured to contain fluid at least partially under a receiving surface of the fluid, and wherein the second portion of the reservoir is configured to contain fluid at least partially under a transmitting surface of the fluid separate from the receiving surface of the fluid.

16. The system of claim 15, further comprising a process module, the process module configured to receive one or more substrates from the cleaning module, to transmit one or more substrates to the cleaning module, or both.

17. The system of claim 16, wherein the process module is a semiconductor process module.

18. The system of claim 16, wherein the cleaning module is integrated with the process module.

19. The system of claim 15, further including a controller, the controller configured to receive information indicative of one or more cleaning process parameters from at least one of the cleaning module and the process module.

20. The system of claim 19, wherein the controller is further configured to provide information indicative of one or more control parameters to at least one of the cleaning module and the process module.
